(19) United States
(12) Patent Application Publication
(10) Pub. No.: US 2011/0061466 A1
(43) Pub. Date: Mar. 17, 2011

(54) Wireless ultrasonic diagnostic apparatus and ultrasonic probe

(75) Inventor: Tomohiro Nishino, Ashigarakami-gun (JP)

(73) Assignee: FUJIFILM Corporation, Tokyo (JP)

(21) Appl. No.: 12/923,113

(22) Filed: Sep. 2, 2010

(30) Foreign Application Priority Data
Sep. 11, 2009 (JP) 2009-210224

(51) Int. Cl. G01N 29/00

(52) U.S. Cl. 73/632

(57) ABSTRACT

A wireless ultrasonic diagnostic apparatus is composed of a first ultrasonic probe, a second ultrasonic probe, and an ultrasonic observation device each having wireless communication function. The first ultrasonic probe is used for ultrasonic diagnosis. The second ultrasonic probe, not being used for the ultrasonic diagnosis, is disposed in an area in which coverage of the first ultrasonic probe and coverage of the ultrasonic observation device overlap with each other. The second ultrasonic probe relays radio detection signals output from the first ultrasonic probe to the ultrasonic observation device.

### FIELD OF THE INVENTION

The present invention relates to a wireless ultrasonic diagnostic apparatus for transmitting and receiving radio signals between an ultrasonic probe and an ultrasonic observation device, and an ultrasonic probe included in this wireless ultrasonic diagnostic apparatus.

### BACKGROUND OF THE INVENTION

Medical diagnoses using an ultrasonic diagnostic apparatus are prevalent. The ultrasonic diagnostic apparatus is composed of an ultrasonic probe and an ultrasonic observation device. At a tip of the ultrasonic probe, ultrasonic transducers (hereinafter referred to as UTs) are arranged. The UTs emit ultrasonic waves to a human body, and receive reflected waves from an object of interest in the human body. Thereby, detection signals are output. The detection signals are electrically processed in the ultrasonic observation device. Thus, an ultrasonic image is obtained.

A wireless ultrasonic diagnostic apparatus is known as one of the examples of the ultrasonic diagnostic apparatus. An ultrasonic probe and an ultrasonic observation device of the wireless ultrasonic diagnostic apparatus have wireless communication function (see Japanese Patent Laid-Open Publications No. 53-108690, No. 55-151952, and No. 2002-085405). In the wireless ultrasonic diagnostic apparatus, detection signals are modulated or converted into radio signals in the ultrasonic probe, and then the radio signals are transmitted to the ultrasonic observation device. The radio signals are demodulated or converted back into the detection signals in the ultrasonic observation device, and thus an ultrasonic image is generated based on the detection signals. A cable for connecting the ultrasonic probe and the ultrasonic observation device is unnecessary, which improves operability of the ultrasonic probe significantly.

The wireless ultrasonic diagnostic apparatus, on the other hand, may cause communication failure between the ultrasonic probe and the ultrasonic observation device due to a position of an operator or a layout of an examination room. For example, in the case where an ultrasonic observation device is located behind an operator, he or she may block the radio signals transmitted from the ultrasonic probe. As a result, the ultrasonic observation device fails to receive the radio signals.

### SUMMARY OF THE INVENTION

An object of the present invention is to provide a wireless ultrasonic diagnostic apparatus capable of carrying out communication between an ultrasonic probe and an ultrasonic observation device in a good condition, and an ultrasonic probe included in this wireless ultrasonic diagnostic apparatus.

In order to achieve the above and other objects, the wireless ultrasonic diagnostic apparatus of the present invention includes multiple ultrasonic probes, an ultrasonic observation device used for the ultrasonic diagnosis, a wireless communication section, and a wireless communication controller. The multiple ultrasonic probes include a first ultrasonic probe being used for ultrasonic diagnosis and one or more second ultrasonic probes not being used for the ultrasonic diagnosis. The wireless communication section is provided in each of the ultrasonic probes and the ultrasonic observation device. The wireless communication section wirelessly transmits and receives a radio signal related the ultrasonic diagnosis. The wireless communication controller is provided in each of the ultrasonic probes to control the wireless communication section. The wireless communication controller of the second ultrasonic probe controls its wireless communication section to relay the radio signal such that the radio signal is communicated between the first ultrasonic probe and the ultrasonic observation device via the one or more second ultrasonic probes.

It is preferable that each of the ultrasonic probes and the ultrasonic observation device has a routing controller for constructing a route for wireless communication between the first ultrasonic probe and the ultrasonic observation device.

It is preferable that each of the ultrasonic probes and the ultrasonic observation device has a received power detector for detecting magnitude of received power of the radio signal received by the wireless communication section. It is preferable that the routing controller constructs the route based on a detection result of the received power detector.

It is preferable that each of the ultrasonic probes and the ultrasonic observation device includes a received power detector and an alarm display section. The received power detector detects received power of the radio signals received by the wireless communication section, and the alarm display section gives an alarm when a detection result of the received power detector is lower than a threshold value.

It is preferable that each of the ultrasonic probes has a backup section for temporarily storing backup data of the radio signals received by the wireless communication section.

It is preferable that the ultrasonic observation device includes a display section for displaying a usage status of the one or more ultrasonic probes.

It is preferable that the radio signal transmitted from the first ultrasonic probe to the ultrasonic observation device via the one or more second ultrasonic probes includes identification information of the first and second ultrasonic probes and probe information indicating the usage status of the first and second ultrasonic probes. It is preferable that the ultrasonic observation device includes a display controller for controlling the display section to display the usage status of the first and second ultrasonic probes in a form of a list based on the identification information and the probe information.

It is preferable that the usage status includes a diagnosing status in which the ultrasonic probe is being used for the ultrasonic diagnosis, a relaying status in which the ultrasonic probe is being used for relaying the radio signals, and a status in which the ultrasonic probe is available for one of the ultrasonic diagnosis and the relaying.

It is preferable each of the ultrasonic probes is provided with an instruction input section for receiving an instruction input signal for operating the ultrasonic probe or the ultrasonic observation device. In the second ultrasonic probe, the wireless communication controller controls the wireless communication section to wirelessly transmit the instruction input signal, received by the instruction input section, to the wireless communication section of the first ultrasonic probe or to the wireless communication section of the ultrasonic observation device. The first ultrasonic probe or the ultrasonic observation device operates according to the received instruction input signal.

It is preferable that the wireless ultrasonic diagnostic apparatus further includes a connection section for connecting the second ultrasonic probe in relay and the ultrasonic observation device via wired connection. The wireless communication section of the connected second ultrasonic probe functions as the wireless communication section of the ultrasonic observation device.

It is preferable that each of the ultrasonic probes is provided with a relay status indicator to indicate that the wireless communication section is relaying the radio signal.

An ultrasonic probe of the present invention includes a wireless communication section and a wireless communication controller. The wireless communication section transmits and receives a radio signal related to ultrasonic diagnosis. The wireless communication controller controls the wireless communication section to relay the radio signal during standby for the ultrasonic diagnosis between other two ultrasonic probes, or between another ultrasonic probe and an ultrasonic observation device used for the ultrasonic diagnosis.

In the present invention, the ultrasonic probe not being used for the ultrasonic diagnosis is used to relay radio signals transmitted and received between the ultrasonic probe being used for the ultrasonic diagnosis and the ultrasonic observation device. Accordingly, even if an operator or an obstruction is located between the ultrasonic probe and the ultrasonic observation device, robust wireless communication network is constructed without being affected by the obstruction. As a result, good communication condition can be kept between the ultrasonic probe and the ultrasonic observation device.

Conventionally, in the case where an ultrasonic observation device is provided with multiple ultrasonic probes, the ultrasonic probes not being used for the ultrasonic diagnosis are of no use. In the present invention, on the other hand, such ultrasonic probes can be used for relaying the radio signals.

The ultrasonic probes and the ultrasonic observation device give an alarm when the detection result of the received power of the radio signal is lower than a predetermined threshold value. As a result, it becomes possible to notify the operator to remove the obstruction between the ultrasonic probe and the ultrasonic observation device or make the ultrasonic probe and the ultrasonic observation device closer to keep the wireless communication in a good condition.

The data of the received radio signal is backed up in the ultrasonic probe for relaying the radio signal. As a result, the radio signal is retransmitted when the ultrasonic probe fails to transmit the radio signal.

The ultrasonic observation device displays the usage status of the ultrasonic probe. Accordingly, it becomes easy to distinguish the ultrasonic probe according to its usage status. In addition, the usage status is displayed in a form of a list. Thus, the usage status of each ultrasonic probe is checked at a glance.

Instead of inputting an operation to the ultrasonic probe being used for ultrasonic diagnosis, the operation can be input to the ultrasonic probe not being used for the diagnosis. As a result, the ultrasonic probe being used for the diagnosis is prevented from being moved due to the input operation during the diagnosis.

During the relaying of the radio signals, the ultrasonic probe displays that it is currently used for the relaying. As a result, the ultrasonic probe is prevented from being used for other purposes during the relaying of the radio signals.

### BRIEF DESCRIPTION OF THE DRAWINGS

The above and other objects and advantages of the present invention will be more apparent from the following detailed description of the preferred embodiments when read in connection with the accompanied drawings, wherein:

FIG. 1 is an external view showing a configuration of a wireless ultrasonic diagnostic apparatus of the first embodiment;

FIG. 2 is a block diagram showing an electrical configuration of an ultrasonic probe;

FIG. 3 is a block diagram showing an electrical configuration of an ultrasonic observation device;

FIG. 4 is an explanatory view showing coverage of a first ultrasonic probe for ultrasonic diagnosis, coverage of a second ultrasonic probe for relaying radio signals, and coverage of an ultrasonic observation device;

FIG. 5 is a functional block diagram of a CPU in each of the first and second ultrasonic probes, and the ultrasonic observation device;

FIG. 6A is an explanatory view of route information showing a source, relay points, and a destination of a radio signal;

FIG. 6B is an explanatory view of route request information that requests to construct a route for wireless communication;

FIG. 7 is an explanatory view showing how the route information is generated;

FIG. 8 is a flowchart showing steps for displaying an ultrasonic image in the wireless ultrasonic diagnostic apparatus of the first embodiment;

FIG. 9 is a block diagram showing an electrical configuration of a wireless ultrasonic diagnostic apparatus of the second embodiment;

FIG. 10 is a flowchart showing steps for backup processing in the wireless ultrasonic diagnostic apparatus of the second embodiment;

FIG. 11 is an explanatory view showing a failure caused in wireless communication between the second ultrasonic probe and the ultrasonic observation device;

FIG. 12 is a block diagram showing an electrical configuration of a wireless ultrasonic diagnostic apparatus of the third embodiment;

FIG. 13 is a flowchart showing steps for displaying a warning in the wireless ultrasonic diagnostic apparatus of the third embodiment;

FIG. 14 is an external view of a wireless ultrasonic diagnostic apparatus of the fourth embodiment;

FIG. 15 is a block diagram showing an electrical configuration of the wireless ultrasonic diagnostic apparatus of the fourth embodiment;

FIGS. 16A to 16D are explanatory views showing how the first route information is generated;

FIGS. 17A to 17C are explanatory views showing second to fourth route information;

FIG. 18 is a flowchart showing steps for selecting route information in the wireless ultrasonic diagnostic apparatus of the fourth embodiment;

FIG. 19 is a block diagram showing an electrical configuration of a wireless ultrasonic diagnostic apparatus of the fifth embodiment;

FIG. 20 is a block diagram showing an electrical configuration of a wireless ultrasonic diagnostic apparatus of the sixth embodiment;

FIG. 21 is a block diagram showing an electrical configuration of a wireless ultrasonic diagnostic apparatus of the seventh embodiment; and

FIG. 22 is a block diagram showing an electrical configuration of a wireless ultrasonic diagnostic apparatus of the eighth embodiment.

### DESCRIPTION OF THE PREFERRED EMBODIMENTS

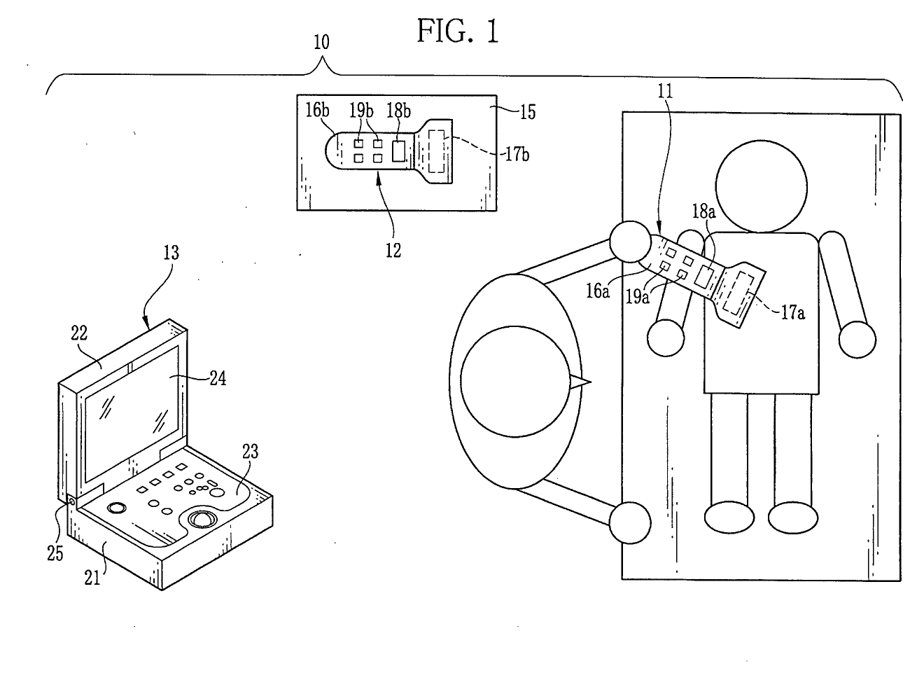

In FIG. 1, a wireless ultrasonic diagnostic apparatus (hereinafter simply referred to as ultrasonic diagnostic apparatus) 10 is composed of an external first ultrasonic probe 11, an external second ultrasonic probe 12, and an ultrasonic observation device 13 or imaging device. The first and second ultrasonic probes 11 and 12 have wireless communication function. The ultrasonic diagnostic apparatus 10 is used for a simplified ultrasonic diagnosis at the bedside of a patient.

The first and second ultrasonic probes 11 and 12 have the same configuration. The first ultrasonic probe 11 is used for the ultrasonic diagnosis. The second ultrasonic probe 12 is not currently used for the ultrasonic diagnosis, and is held in a predetermined probe holder 15 as an access point position. Hereinafter, a suffix “a” is added to a numeral of a part or member related to the first ultrasonic probe 11, and a suffix “b” is added to a numeral of a part or member related to the second ultrasonic probe 12.

The first ultrasonic probe 11 is composed of a scan head 16a, an ultrasonic transducer array (hereinafter abbreviated as UT array) 17a incorporated along a tip of the scan head 16a, a power switch 18a and an operation switch 19a. The power switch 18a and the operation switch 19a are provided substantially in the middle of the scan head 16a. The second ultrasonic probe 12 is composed of a scan head 16b, an ultrasonic transducer array (hereinafter abbreviated as UT array) 17b incorporated along a tip of the scan head 16b, a power switch 18b, and an operation switch 19b. The power switch 18b and an operation switch 19b are provided substantially in the middle of the scan head 16b. The scan heads 16a and 16b are held by an operator and placed on a body surface of a patient.

The UT arrays 17a and 17b emit ultrasonic waves to an object of interest inside the body of the patient, and receive the ultrasonic waves or echo reflected from the object of interest. The power switches 18a and 18b turn on or off the first and second ultrasonic probes 11 and 12, respectively.

The operation switches 19a and 19b are used for the operations of the first and second ultrasonic probes 11 and 12, respectively. In addition, the operation switches 19a and 19b are used for changing or selecting the operation modes and sending various operation orders or instructions to the ultrasonic observation device 13. The operation modes of the first and second ultrasonic probes 11 and 12 include an observation mode or imaging mode in which ultrasonic waves are transmitted, and a standby mode in which all functions are disabled except for the wireless communication.

The ultrasonic observation device 13 is composed of a body 21 and a cover 22. On a top face of the body 21, an operating section 23 is disposed. The operating section 23 is provided with multiple buttons and a trackball for inputting various operating instructions to the ultrasonic observation device 13. Inside the cover 22, a monitor 24 is provided. The monitor 24 displays ultrasonic images and various operation screens.

The cover 22 is attached to the body 21 through a hinge 25. The cover 22 is rotatable between an open position and a closed position. In the open position, the operating section 23 and the monitor 24 are exposed. In the closed position, the cover 22 covers the top surface of the body 21 to protect the operating section 23 and the monitor 24.

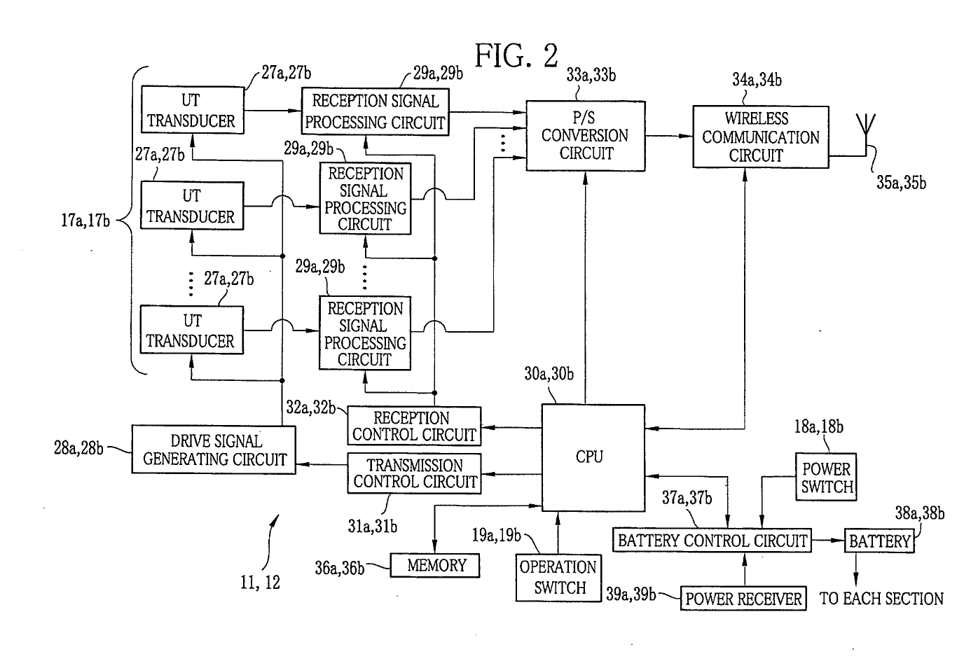

In FIG. 2, the UT arrays 17a and 17b are provided with ultrasonic transducers (hereinafter referred to as UTs) 27a and 27b spaced uniformly. The UTs 27a and 27b are composed of piezoelectric elements and oscillate in response to excitation pulses input from drive signal generating circuits 28a and 28b, respectively, to transmit ultrasonic waves to an object of interest. The UTs 27a and 27b receive the reflected waves from the object of interest, and outputs detection signals to the reception signal processing circuits 29a and 29b, respectively.

Under the control of CPUs 30a and 30b, the drive signal generating circuits 28a and 28b are driven by transmission control circuits 31a and 31b, respectively. Based on orders from the transmission control circuits 31a and 31b, the drive signal generating circuits 28a and 28b select the UTs 27a and 27b to which the excitation pulses are input, respectively. The drive signal generating circuits 28a and 28b sequentially switch or change the UTs 27a and 27b to be driven at a predetermined time interval, respectively. For example, in the case where there are 128 UTs 27a and 128 UTs 27b, adjacent 48 UTs 27a are selected as a block to be driven, and adjacent 48 UTs 27b are selected as a block to be driven. Every time a transmission and reception of ultrasonic waves takes place, the next block of the UTs 27a, one or several UTs 27a away from the previous block, and the next block of the UTs 27b, one or several UTs 27b away from the previous block, are driven.

Based on orders from the transmission control circuits 31a and 31b, the drive signal generating circuits 28a and 28b change timings to input excitation pulses to the UTs 27a in one block and to the UTs 27b in one block, respectively. Thereby, electronic scan is performed in the transmission directions of the ultrasonic waves, or the ultrasonic waves are electronically focused. Each of the transmission control circuits 31a and 31b generates delay pattern information every time a transmission and reception of ultrasonic waves takes place. The delay pattern information specifies timings to input the excitation pulses to the UTs 27a and 27b.

Each UT 27a is provided with one reception signal processing circuit 29a. Each UT 27b is provided with one reception signal processing circuit 29b. In other words, the number of the reception signal processing circuits 29a is the same as that of the UTs 27a, and the number of the reception signal processing circuits 29b is the same as that of the UTs 27b. Under the control of the CPUs 30a and 30b, the reception signal processing circuits 29a and 29b are driven by reception control circuits 32a and 32b, respectively.

Each of the reception signal processing circuits 29a and 29b is provided with a reception amplifier, and an A/D converter (hereinafter referred to as A/D). The reception amplifiers amplify the detection signals input from the UTs 27a and 27b, respectively. Then, the A/Ds digitally modulate the detection signals. The reception signal processing circuits 29a and 29b are connected to parallel/serial conversion circuits (hereinafter referred to as P/S conversion circuits 33a and 33b, respectively.

The detection signals from the reception signal processing circuits 29a and 29b are input in parallel to the P/S conversion circuits 33a and 33b, respectively, every time a transmission and reception of ultrasonic waves takes place. In the case where one block is composed of 48 UTs 27a, and the other block is composed of 48 UTs 27b, parallel signals of 48 bits are input to each of the P/S conversion circuits 33a and 33b. Under the control of the CPUs 30a and 30b, the P/S conversion circuits 33a and 33b synchronize clock signals input from synchronization circuits (not shown), respectively, and each of the P/S conversion circuits 33a and 33b modulates or converts the parallel signals of 48 bits into serial signals. The P/S conversion circuits 33a and 33b are connected to wireless communication circuits 34a and 34b, respectively.

Under the control of the CPU 30a and 30b, the wireless communication circuits 34a and 34b transmit and receive radio signals to and from other ultrasonic probes and the ultrasonic observation device 13 through antennas 35a and 35b. The wireless communication circuits 34a and 34b modulate the serial signals input from the P/S conversion circuits 33a and 33b and various signals input from the CPUs 30a and 30b into the radio signals. The radio signals are output to the antennas 35a and 35b. The wireless communication circuits 34a and 34b demodulate or convert the radio signals, received through the antennas 35a and 35b, back into the serial signals or the like.

Based on instruction input signals from the operation switches 19a and 19b, the CPUs 30a and 30b sequentially execute various programs read from ROM areas of memories 36a and 36b to control overall operations of the first and second ultrasonic probes 11 and 12, respectively. RAM areas of the memories 36a and 36b function as working memories for the CPUs 30a and 30b, respectively. The CPUs 30a and 30b execute processes or temporarily store various data in the RAM areas.

In addition, battery control circuits 37a and 37b are connected the CPUs 30a and 30b, respectively. To the battery control circuits 37a and 37b are connected the power switches 18a and 18b, batteries 38a and 38b, and power receivers 39a and 39b, respectively.

When the power switches 18a and 18b are turned on, under the control of the CPUs 30a and 30b, the battery control circuits 37a and 37b control the batteries 38a and 38b to supply the power to the first and second ultrasonic probes 11 and 12, respectively.

The power receivers 39a and 39b receive the power supplied by an external charger (not shown). The battery control circuits 37a and 37b charge the batteries 38a and 38b with the power supplied via the power receivers 39a and 39b, respectively.

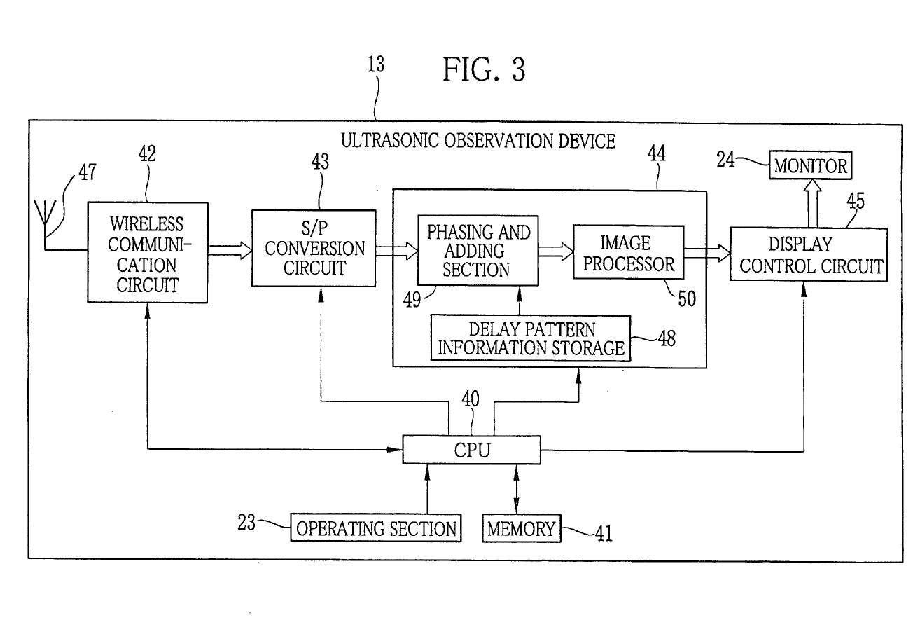

As shown in FIG. 3, the ultrasonic observation device 13 is provided with a CPU 40, a memory 41, a wireless communication circuit 42, a serial/parallel conversion circuit (hereinafter referred to as S/P conversion circuit) 43, an image forming circuit 44, a display control circuit 45, and the like, in addition to the operating section 23 and the monitor 24. Based on the instruction input signals from the operating section 23, the CPU 40 sequentially executes a program read from the memory 41 to control overall operations of the ultrasonic observation device 13.

The wireless communication circuit 42 of the ultrasonic observation device 13 is basically the same as the above described wireless communication circuits 34a and 34b. The wireless communication circuit 42 communicates with the ultrasonic probes 11 and 12 using radio signals through an antenna 47. The wireless communication circuit 42 demodulates various signals input from the CPU 40 into radio signals, and outputs the radio signals to the antenna 47.

The wireless communication circuit 42 demodulates the radio signals, received through the antenna 47, into the above-described serial signals, for example. The wireless communication circuit 42 outputs the demodulated serial signals to the S/P conversion circuit 43, and other demodulated signals to the CPU 40.

The S/P conversion circuit, 43 synchronizes with clock signals input from a phase synchronization circuit (not shown), and demodulates or converts the serial signals back into the parallel signals, that is, one block of the detection signals. The image forming circuit 44 is connected to the S/P conversion circuit 43.

The image forming circuit 44 is provided with a delay-pattern information storage 48, a phasing and adding section 49, and an image processor 50. The delay-pattern information storage 48 stores the above described delay pattern information which wireless communication circuit 42 wirelessly received from the ultrasonic probes 11 and 12.

The phasing and adding section 49 refers to the delay pattern information stored in the delay-pattern information storage 48, and performs phasing and adding to the detection signals such that the detection signals are in phase with each other. Specifically, the detection signals input from the S/P conversion circuit 43 are sequentially stored on a block-by-block basis, and then the stored detection signals are subjected to phasing and adding when all the detection signals from the UTs 27a and 27b are stored.

The image processor 50 performs various signal processes such as gain correction, log compression, detection, edge enhancement, and filter processing to the detection signals output from the phasing and adding section 49, and then modulates or converts the detection signals into TV signals. The display control circuit 45 performs D/A conversion to the TV signals output from the image processor 50 to display an ultrasonic image on the monitor 24.

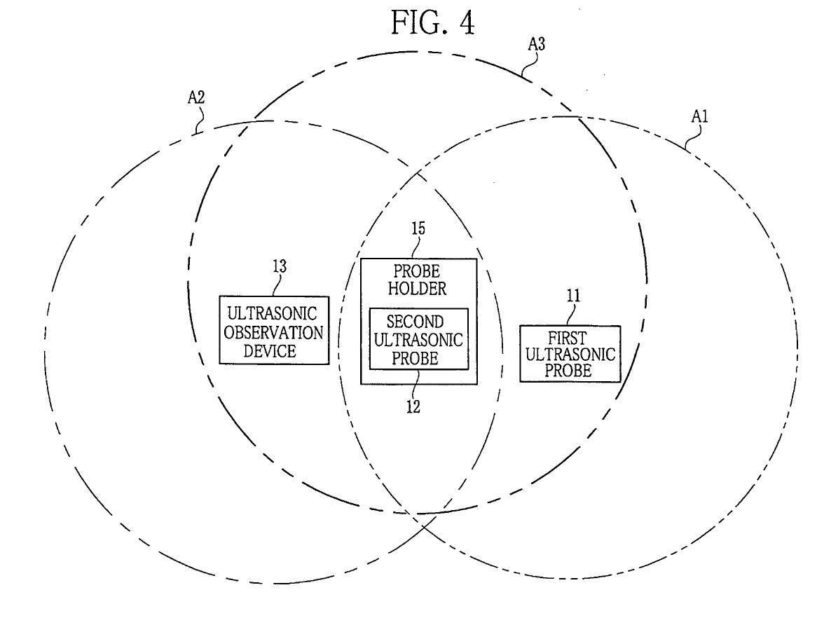

As shown in FIG. 4, the probe holder 15 is placed in an area where coverage A1 of the first ultrasonic probe 11 and coverage A2 of the ultrasonic observation device 13 overlap with each other. In other words, the first ultrasonic probe 11 and the ultrasonic observation device 13 are located inside coverage A3 of the second ultrasonic probe 12.

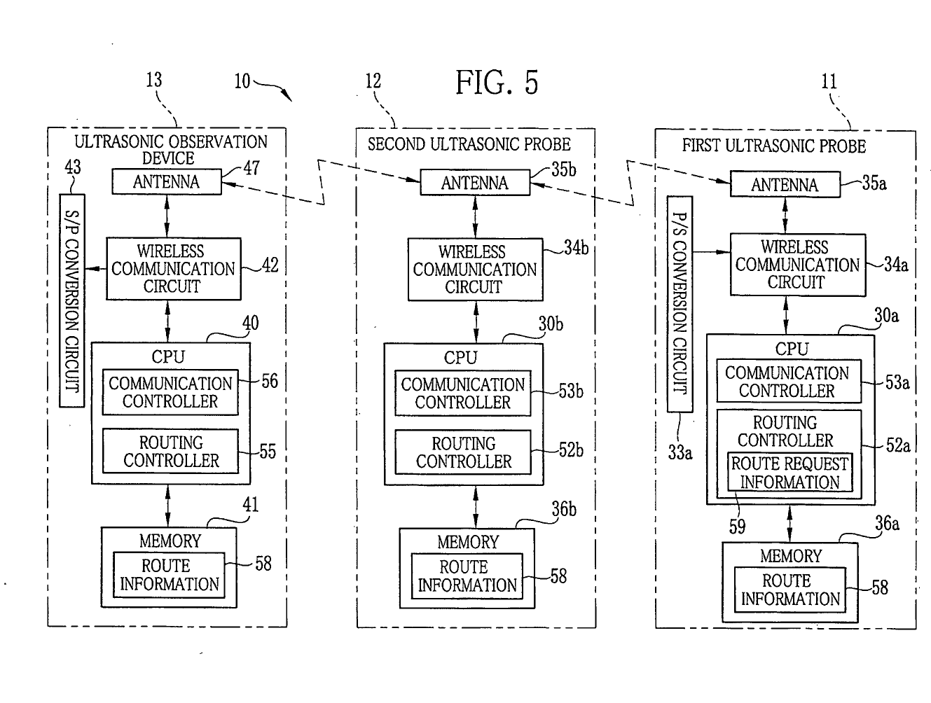

As shown in FIG. 5, the CPUs 30a and 30b read programs from the memories 36a and 36b, and sequentially execute the read programs, respectively. Thereby, the CPU 30a of the first ultrasonic probe 11 functions as a routing controller 52a and a communication controller 53a, and the CPU 30b of the second ultrasonic probe 12 functions as a routing controller 52b and a communication controller 53b. Likewise, the CPU 40 of the ultrasonic observation device 13 functions as a routing controller 55 and a communication controller 56.

The routing controllers 52a, 52b, and 55 control the wireless communication circuits 34a, 34b, and 42, respectively, such that the wireless communication circuits located in the same coverage wirelessly communicate with each other. Thereby, route information 58 is generated or constructed. The route information 58 indicates one or more transmission routes of the radio signals between the first ultrasonic probe 11 and the ultrasonic observation device 13. The wireless communications among the routing controllers 52a, 52b, and 55 are conducted via the wireless communication circuits and the antennas. However, for the sake of simplification, description on the wireless communication circuits and the antennas are omitted.

The routing controller 52a wirelessly communicates with the routing controller 52b. The routing controller 52b wirelessly communicates with each of the routing controller 52a and the routing controller 55. Accordingly, the routing controller 52b relays data transmitted from one of the routing controller 52a and the routing controller 55 to the other.

Data transmitted from the routing controller 52a includes route request information 59 requesting the generation of the route information 58 destined to the ultrasonic observation device 13. The route request information 59 is transmitted, for example, when the operation mode of the ultrasonic probe 11 is changed to the observation mode, or when the ultrasonic diagnosis using the ultrasonic probe 11 is started. The route request information 59 may be transmitted at a certain time interval.

Data transmitted from the routing controller 55 of the ultrasonic observation device 13 includes the route information 58 responding to the route request information 59. Every time the routing controller 55 receives the route request information 59, the routing controller 55 transmits the route information 58, and stores the route information 58 in the memory 41. The routing controller 52a stores the received route information 58 in the memory 36a. The routing controller 52b stores the received route information 58 in the memory 36b.

A communication controller 53a of the first ultrasonic probe 11 controls the wireless communication circuit 34a to sequentially perform the wireless transmission of the serial signals, output from the P/S conversion circuit 33a, on the block-by-block basis to the next recipient in the route information 58. Hereinafter, radio signals into which the serial signals are modulated may be referred to as radio serial signals.

The communication controller 53b of the second ultrasonic probe 12 controls the wireless communication circuit 34b to sequentially relay the radio serial signals received by the wireless communication circuit 34b to next recipient stored in the route information 58. The communication controller 56 of the ultrasonic observation device 13 controls the reception of the radio serial signals by the wireless communication circuit 42.

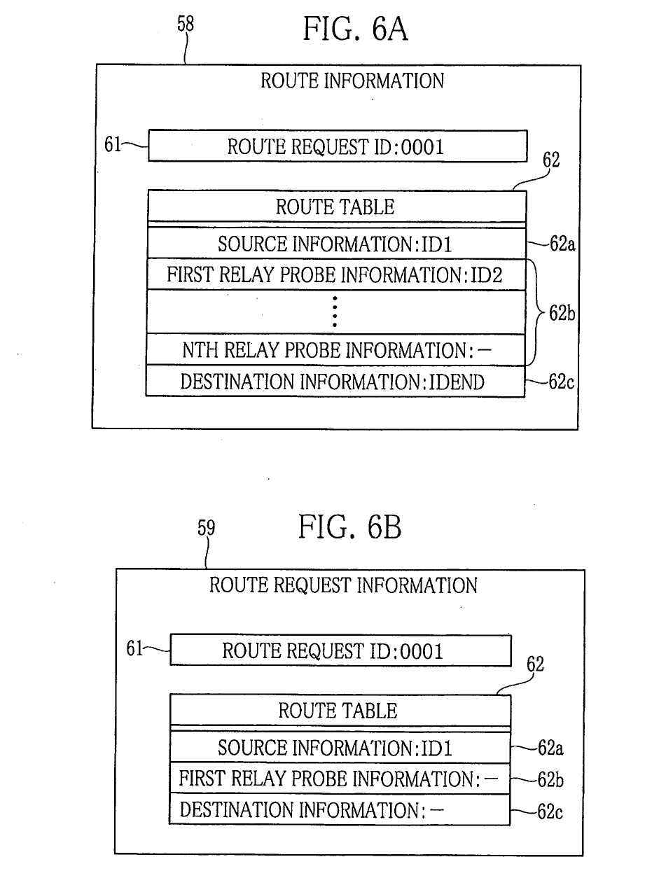

As shown in FIG. 6A, the route information 58 is composed of a box 61 for a route request ID and a route table 62. In the box 61, the route request ID assigned to the route request information 59 by the routing controller 52a is stored. Every time new route request information 59 is issued, the route request ID is incremented by one. In other words, the larger the number of the route request ID, the newer the route information 58 is.

The route table 62 indicates one or more transmission routes of the radio signals. The route table 62 is provided with a box 62a for source information, a box 62b for relay probe information, and a box 62c for destination information. In the box 62a for source information, identification information of a sender of the radio signals (hereinafter referred to as a source) is displayed. In the box 62b for the relay probe information, identification information of a probe (hereinafter referred to as relay probe) used for relaying the radio signals is displayed. In the box 62c for destination information, identification information of a final recipient (hereinafter referred to as destination) is displayed.

In the box 62a for source information, the identification information of the first ultrasonic probe 11 is stored. In the box 62b for the relay probe information, the identification information of the second ultrasonic probe 12 is stored. In the case where there are two or more relay probes or access point devices, identification information of each of the relay probes is stored in the box 62b in the order of the relay. In the box 62c for destination information, the identification information of the ultrasonic observation device 13 is stored. The identification information includes, for example, IP addresses, ID numbers, or the like of the ultrasonic probes 11, 12, and the ultrasonic observation device 13. In FIG. 6A, the ID numbers are shown as an example of the identification information.

As shown in FIG. 6B, the route information 58 is based on the route request information 59. The route request information 59 is composed of the box 61 for route request ID and the route table 62 in the same way as the route information 58 except that the route request information 59 has the blank box 62b for the relay probe information and the blank box 62c for destination information when the route request information 59 is generated by the routing controller 52a.

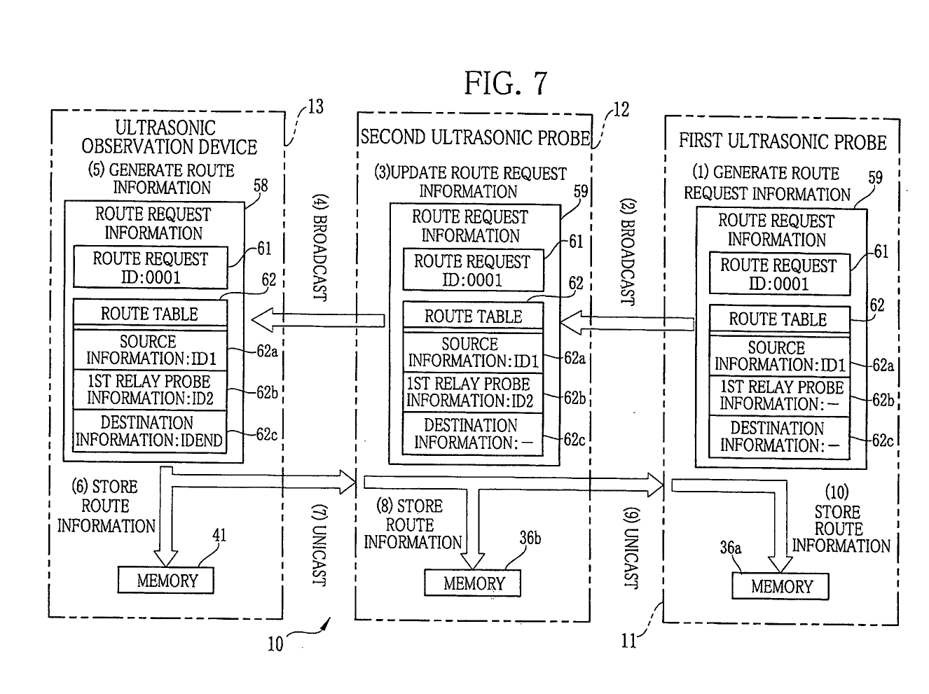

Next, with referring to FIG. 7, generation of the route information 58 is described. When the observation mode is selected for the first ultrasonic probe 11, the routing controller 52a generates the route request information 59 as shown in the step (1).

Thereafter, in the first ultrasonic probe 11, the routing controller 52a sends the generated route request information 59 to the wireless communication circuit 34a, and orders the wireless communication circuit 34a to broadcast the generated route request information 59. Here, “to broadcast” is to transmit the same information simultaneously to any number of the ultrasonic probes and/or the ultrasonic observation device 13.

As shown in the step (2), in the first ultrasonic probe 11, upon receiving the order to broadcast, the wireless communication circuit 34a modulates the route request information 59 into the radio signals and broadcasts them through the antenna 35a. The second ultrasonic probe 12 is located within the coverage A1 of the first ultrasonic probe 11, and receives the radio signals from the first ultrasonic probe 11 through the antenna 35b.

In the second ultrasonic probe 12, the radio signals received through the antenna 35b are demodulated into the route request information 59 by the wireless communication circuit 34b, and output to the routing controller 52b. The routing controller 52b refers to the route request information 59 and checks whether the identification information of this second ultrasonic probe 12 has already been stored in the route table 62. If so, it means that this second ultrasonic probe 12 has received the same route request information 59 for the second time. In this case, the routing controller 52b of this second ultrasonic probe 12 cancels or discards the route request information 59.

On the other hand, in the case where the identification information of the second ultrasonic probe 12 has not been stored in the route table 62 of the route request information 59, it means that the second ultrasonic probe 12 has received the route request information 59 for the first time. In this case, the routing controller 52b updates the route request information 59 by storing the identification information of the second ultrasonic probe 12 in the box 62b for the relay probe information as shown in the step (3). The identification information is stored as first relay probe information indicating the first relay probe.

In the second ultrasonic probe 12, the routing controller 52b sends the updated route request information 59 to the wireless communication circuit 34b, and orders the wireless communication circuit 34b to broadcast the updated route request information 59. Thereby, as shown in the step (4), the radio signals into which the route request information 59 is modulated are broadcasted through the antenna 35b. In the coverage A3 of the second ultrasonic probe 12, the first ultrasonic probe 11 and the ultrasonic observation device 13 are located. The first ultrasonic probe 11 receives the radio signals through the antenna 35a, and the ultrasonic observation device 13 receives the radio signals through the antenna 47.

In the first ultrasonic probe 11, the radio signals received through the antenna 35a are demodulated into the route request information 59 by the wireless communication circuit 34a. The route request information 59 is input to the routing controller 52a. Since the identification information of the first ultrasonic probe 11 has already been stored in the route request information 59, the routing controller 52a cancels or discards this route request information 59.

In the ultrasonic observation device 13, on the other hand, the radio signals received through the antenna 47 are demodulated into the route request information 59 by the wireless communication circuit 42. The route request information 59 is input to the routing controller 55. As shown in the step (5), the routing controller 55 stores the identification information of the ultrasonic observation device 13 in the box 62c for destination information of the route request information 59, and generates the route information 58. Thus, the transmission route of the radio signals between the first ultrasonic probe 11 and the ultrasonic observation device 13 is determined.

Next, as shown in the step (6), in the ultrasonic observation device 13, the replication of the route information 58 is stored in the memory 41. Thereafter, the routing controller 55 sends the route information 58 to the wireless communication circuit 42, and orders to unicast the route information 58. Here, “to unicast” is to send information to a single designated recipient. The routing controller 55 refers to the route information 58, and designates the immediately preceding sender of the route request information 59, namely, the second ultrasonic probe 12 as the recipient.

As shown in the step (7), in the ultrasonic observation device 13, the wireless communication circuit 42 modulates the route information 58 into the radio signals upon receiving the order to unicast the route information 58, and unicasts the radio signals through the antenna 47. The unicast radio signals are received by the second ultrasonic probe 12, designated as the recipient, through the antenna 35b.

In the second ultrasonic probe 12, the received radio signals are demodulated into the route information 58, and input to the routing controller 52b. As shown in the step (8), the routing controller 52b stores the copy or replication of the route information 58 in the memory 36b.

Next, in the second ultrasonic probe 12, as with the routing controller 55 of the ultrasonic observation device 13, the routing controller 52b refers to the route information 58, and issues an order to the wireless communication circuit 34b to unicast the route information 58 to the first ultrasonic probe 11, which is the source of the route request information 59, as the designated recipient. Thereby, as shown in the step (9), the radio signals into which the route information 58 is modulated are unicast through the antenna 35b.

The first ultrasonic probe 11 and the ultrasonic observation device 13 receive the unicast radio signals through the antennas 35a and 47, respectively. The ultrasonic observation device 13 cancels or discards the received radio signals if the designated recipient of the received radio signals is not the ultrasonic observation device 13.

On the other hand, in the first ultrasonic probe 11 designated as the recipient, the received radio signals are demodulated into the route information 58 and input to the routing controller 52a. As shown in the step (10), the routing controller 52a stores the route information 58 in the memory 36a. Thus, the route information 58 generated in the ultrasonic observation device 13 is transmitted to the second ultrasonic probe 12 and then to the first ultrasonic probe 11, retracing the transmission route of the route request information 59.

As described above, the route information 58 is shared among the first ultrasonic probe 11, the second ultrasonic probe 12, and the ultrasonic observation device 13. The radio signals are transmitted and received among the first ultrasonic probe 11, the second ultrasonic probe 12, and the ultrasonic observation device 13 without the use of an external radio base station, namely, a wireless communication network is established among the first ultrasonic probe 11, the second ultrasonic probe 12, and the ultrasonic observation device 13.

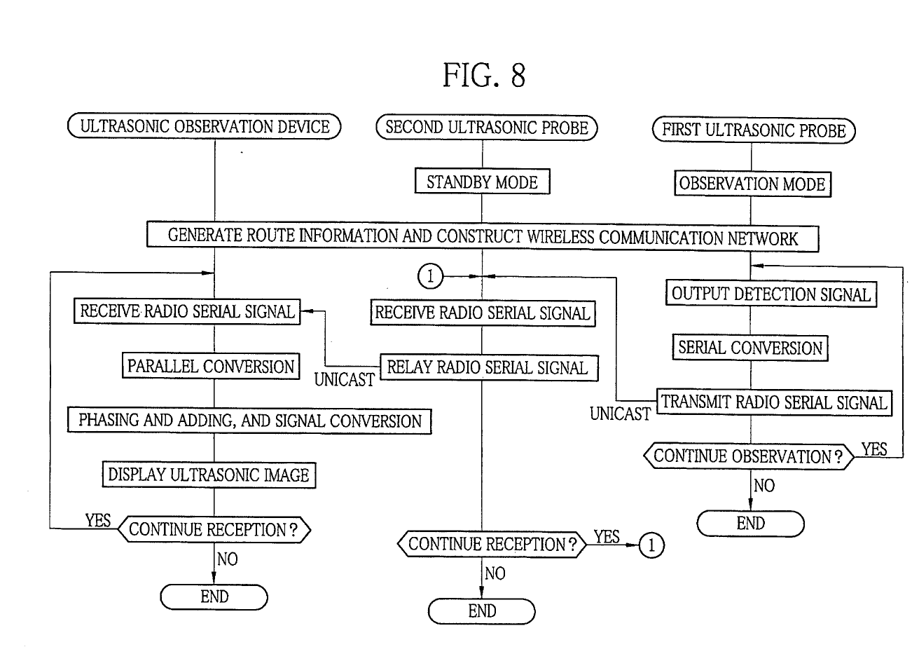

Next, with referring to FIG. 8, an operation of the ultrasonic diagnostic apparatus 10 is described. The second ultrasonic probe 12 is turned on and put into the standby mode, and then held in the probe holder 15 as an access point position while being kept in the standby mode. Thereby, the second ultrasonic probe 12 is in a state of an access point device where all functions are disabled except for wireless communication.

When the first ultrasonic probe 11 and the ultrasonic observation device 13 are turned on, the CPUs 30a and 40 start to control the operations of the first ultrasonic probe 11 and the ultrasonic observation device 13, respectively. Then, through the operation switch 19a, the first ultrasonic probe 11 is put into the observation mode to perform the ultrasonic diagnosis.

After the first ultrasonic probe 11 is put into the observation mode, the generation of the route information 58 is executed as described with referring to FIG. 7. The route information 58 is stored in the memory 36a of the first ultrasonic probe 11, the memory of 36b of the second ultrasonic probe 12, and the memory 41 of the ultrasonic observation device 13. Thereby, a wireless communication network is established among the first ultrasonic probe 11, the second ultrasonic probe 12, and the ultrasonic observation device 13.

An operator places the scan head 16a of the first ultrasonic probe 11 on a surface of the body of a patient. In the first ultrasonic probe 11, the drive signal generating circuit 28a sends excitation pulses to the UTs 27a selected by the transmission control circuit 31a, and the ultrasonic waves are emitted from the UTs 27a to the object of interest. Every time a transmission and reception of the ultrasonic waves takes place, the UTs 27a selected by the transmission control circuit 31a are switched or changed sequentially. Thereby, the object of interest is scanned with the ultrasonic waves. The transmission control circuit 31a generates the delay pattern information every time a transmission and reception of ultrasonic waves takes place.

The emitted ultrasonic waves are reflected by the object of interest, and the UTs 27a receive the reflected waves and outputs the detection signals. The detection signals are amplified and digitally modulated in the reception signal processing circuit 29a. The digitized detection signals are sent to the P/S conversion circuit 33a, and then modulated into serial signals. The serial signals are sent to the wireless communication circuit 34a.

The communication controller 53a of the CPU 30a refers to the route information 58 in the memory 36a, and determines the second ultrasonic probe 12 as the next recipient of the serial signals, and orders the wireless communication circuit 34a to unicast the serial signals to the second ultrasonic probe 12. Thereby, the first ultrasonic probe 11 unicasts the radio serial signals through the antenna 35a and the second ultrasonic probe 12 receives the radio serial signals through the antenna 35b.

In the second ultrasonic probe 12, the radio serial signals are demodulated into the serial signals in the wireless communication circuit 34b, and temporarily stored in the memory 36b. Then, the communication controller 53b sends the serial signals, stored in the memory 36b, to the wireless communication circuit 34b. The communication controller 53b refers to the route information 58, and issues an order to the wireless communication circuit 34b to unicast the serial signals to the ultrasonic observation device 13 designated as the next recipient. Thereby, the radio serial signals are unicast from the second ultrasonic probe 12 through the antenna 35b.

The first ultrasonic probe 11 and the ultrasonic observation device 13 receive the radio serial signals through the antennas 35a and 47, respectively. As with the above described unicast transmission of the route request information 59, the first ultrasonic probe 11 cancels or discards the radio serial signals received through the antenna 35a.

As described above, the second ultrasonic probe 12 relays the radio serial signals transmitted from the first ultrasonic probe 11 to the ultrasonic observation device 13. The ultrasonic observation device 13 surely receives the signals transmitted from the first ultrasonic probe 11 even if there is an obstruction between the first ultrasonic probe 11 and the ultrasonic observation device 13.

In the first ultrasonic probe 11, the delay pattern information generated by the transmission control circuit 31a is modulated into radio signals, and the radio signals are transmitted concurrently with or after the transmission of the radio serial signals. The radio signals are also relayed to the ultrasonic observation device 13 through the second ultrasonic probe 12.

In the ultrasonic observation device 13, the communication controller 56 controls the wireless communication circuit 42 to demodulate various radio signals, received through the antenna 47, into the serial signals and the delay pattern information. The serial signals are sent to the S/P conversion circuit 43. The delay pattern information is sent to the delay-pattern information storage 48 through the CPU 40. The S/P conversion circuit 43 performs parallel conversion to convert the input serial signals back into one block of the detection signals and sends the detection signals to the phasing and adding section 49.

The detection signals of all the UTs 27a are accumulated in the phasing and adding section 49, and the delay pattern information is stored in the delay-pattern information storage 48 on a block basis. The phasing and adding section 49 performs phasing and adding of the detection signals based on the delay pattern information stored in the delay-pattern information storage 48. Thereafter, the detection signals are subjected to various signal processing in the image processor 50 and then modulated into TV signals. The TV signals are subjected to D/A conversion by the display control circuit 45, and then displayed as an ultrasonic image on the monitor 24.

In the above embodiment, the second ultrasonic probe 12 not being used for the ultrasonic diagnosis is put in the probe holder 15. The ultrasonic probe 12 may be placed anywhere in an access point position where the coverage A1 of the first ultrasonic probe 11 and the coverage A2 of the ultrasonic observation device 13 overlap, for example, the ultrasonic probe 12 may be placed on a bedside table or a chair, or hung from the ceiling.

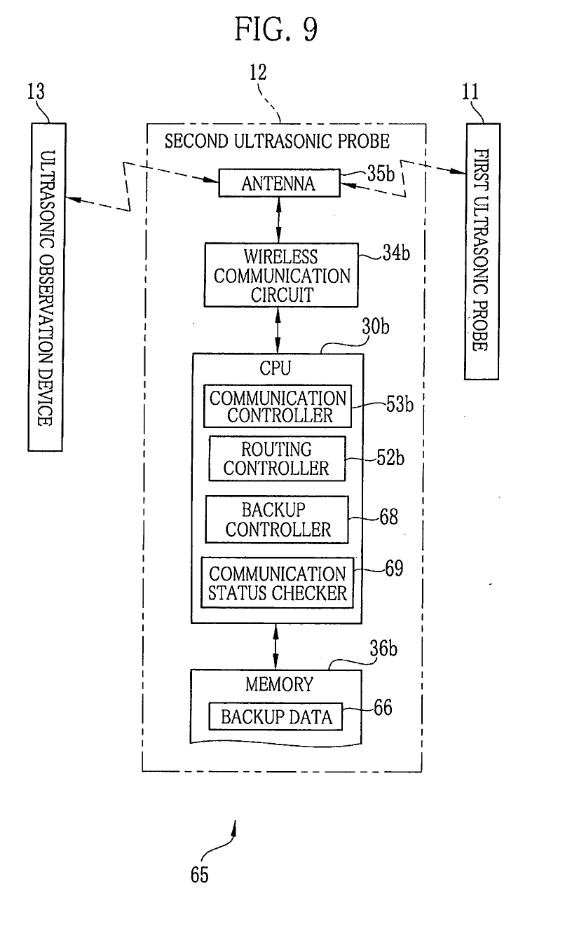

Next, with referring to FIG. 9, an ultrasonic diagnostic apparatus 65 of the second embodiment in the present invention is described. The ultrasonic diagnostic apparatus 65 basically has the same configuration as the ultrasonic diagnostic apparatus 10 of the first embodiment. In the following embodiments, a part or member the same as or similar to that in FIGS. 2 and 5 of the above first embodiment is designated by the same numeral as the first embodiment, and descriptions thereof are omitted.

In the ultrasonic diagnostic apparatus 65, backup data 66 of the radio signals to be relayed through the second ultrasonic probe 12 is generated and stored in the memory 36b. The CPU 30b of the second ultrasonic probe 12 functions as a backup controller 68 and a communication status checker 69.

The backup controller 68 controls the backup of the various signals received by the wireless communication circuit 34b. The communication status checker 69 checks whether there is a communication failure between the second ultrasonic probe 12 and the ultrasonic observation device 13. If a communication failure is detected, the communication status checker 69 issues an order to the communication controller 53b to retransmit the previously transmitted signals.

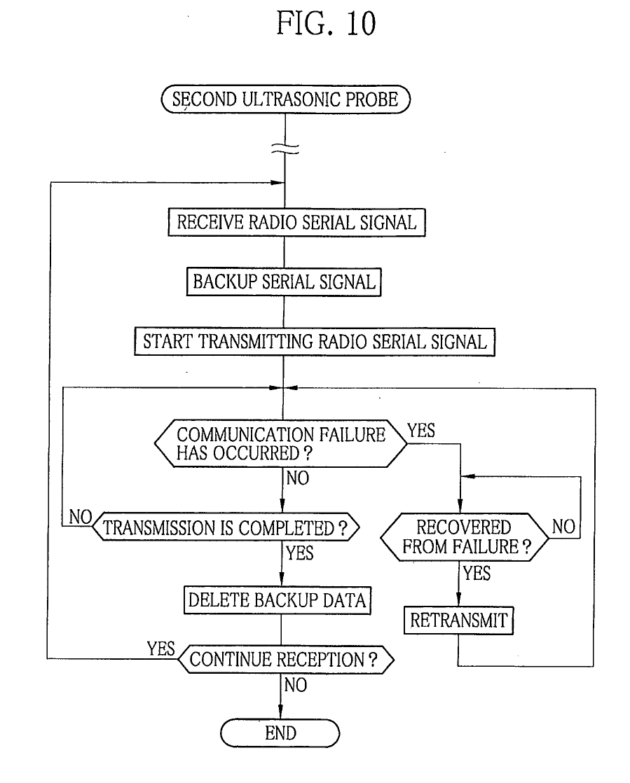

In FIG. 10, an operation of the ultrasonic diagnostic apparatus 65 having the above configuration is described. In the following embodiments, descriptions already described in the first embodiment are omitted. The second ultrasonic probe 12 receives one block of the radio serial signals through the antenna 35b. The radio serial signals are modulated into the serial signals in the wireless communication circuit 34b, and then temporarily stored in the memory 36b.

The backup controller 68 copies the serial signals in the memory 36b to create the backup data 66. Thereafter, the serial signals in the memory 36b are demodulated into the radio serial signals in the wireless communication circuit 34b, and then transmitted to the ultrasonic observation device 13 through the antenna 35b.

When the transmission of the radio serial signals is started using the second ultrasonic probe 12, the communication status checker 69 checks the communication status between the second ultrasonic probe 12 and the ultrasonic observation device 13. For example, the communication status checker 69 controls the wireless communication circuit 34b to send the ultrasonic observation device 13 a request to check the communication status at regular time intervals, and checks whether a reply signal from the ultrasonic observation device 13 is received. The communication status checker 69 judges the communication status good when it receives the reply signal from the ultrasonic observation device 13.

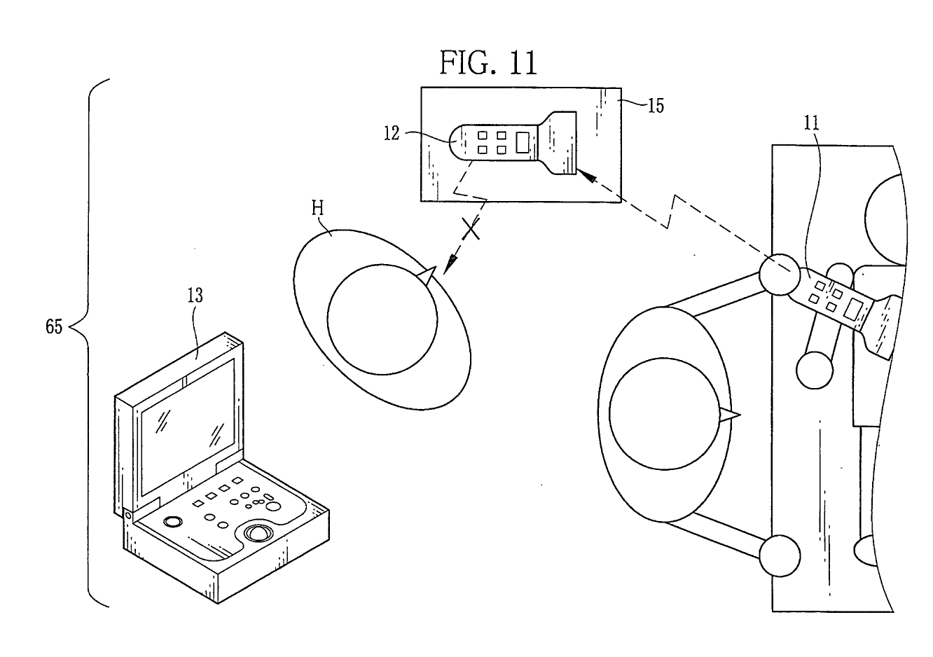

On the other hand, for example, as shown in FIG. 11, in the case where a person H is present between the second ultrasonic probe 12 and the ultrasonic observation device 13, this person H may block the radio signals transmitted from the second ultrasonic probe 12. Accordingly, the ultrasonic observation device 13 cannot receive the request to check the communication status, and the reply signal is not transmitted from the ultrasonic observation device 13. Thereby, the communication status checker 69 judges that a communication failure is occurring between the second ultrasonic probe 12 and the ultrasonic observation device 13.

The communication status checker 69 continues the transmission of the communication status request after the judgment of the communication failure. When the person H moves and no longer blocks the communication between the second ultrasonic probe 12 and the ultrasonic observation device 13, the ultrasonic observation device 13 receives the communication status request and resumes the transmission of the reply signal.

In FIG. 10, when the ultrasonic observation device 13 resumes the transmission of the reply signal, the communication status checker 69 determines that the communication failure is resolved, so the communication status checker 69 issues an order to the communication controller 53b to retransmit the radio serial signals. The communication controller 53b reads the backup data stored in the memory 36b, and controls the wireless communication circuit 34b to retransmit the radio serial signals.

As described above, the radio serial signals are surely relayed even if the communication between the second ultrasonic probe 12 and the ultrasonic observation device 13 is temporarily interrupted. The above described processes are repeated until the transmission of one block of the radio serial signals is completed.

After the completion of the transmission of one block of the radio serial signals, the backup controller 68 deletes the backup data 66 corresponding to the transmitted radio serial signals from the memory 36b. The subsequent processes are the same as in the first embodiment, and descriptions thereof are omitted.

In the above second embodiment, the backup data 66 is sequentially stored in the memory 36b. However, if the interruption time of the communication between the second ultrasonic probe 12 and the ultrasonic observation device 13 is long, an amount of the backup data 66 stored in the memory 36b increases while a remaining capacity of the memory 36b decreases. In this case, the second ultrasonic probe 12 and/or the ultrasonic observation device 13 may provide an alarm or warning, for example, an LED lamp or beep sound, to notify the operator the communication failure.

In the above second embodiment, the backup of the serial signals is performed in the second ultrasonic probe 12 as an example. Alternatively or in addition, the backup of the serial signals may be performed in the first ultrasonic probe 11. Information other than the serial signals may also be backed up. For example, the delay pattern information, the route request information 59 and/or the route information 58 may be backed up in the same manner as the above. In the case that the communication status checker 69 determines that the communication failure is occurring, the first ultrasonic probe 11 may stop the ultrasonic scanning, and resume the scanning when the communication failure is resolved. Thereby, power savings are achieved.

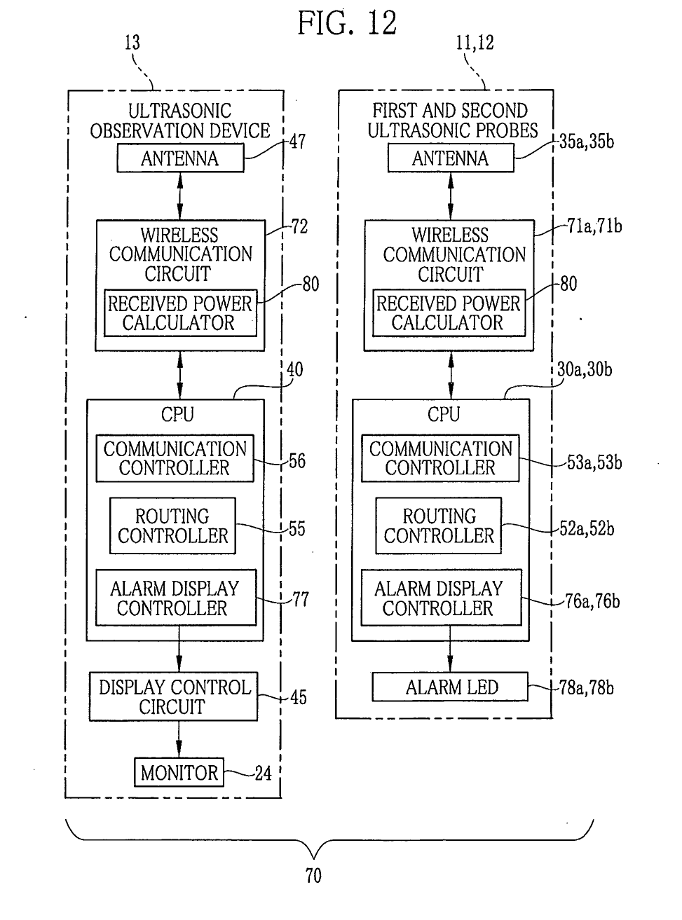

Next, with referring to FIG. 12, an ultrasonic diagnostic apparatus 70 of the third embodiment of the present invention is described. The ultrasonic diagnostic apparatus 70 basically has the same configuration as the ultrasonic diagnostic apparatus 10 shown in FIG. 1 of the first embodiment except that in the ultrasonic diagnostic apparatus 70, wireless communication circuits 71a, 71b, and 72, different from those in the first embodiment, are provided in the first and second ultrasonic probes 11 and 12, and the ultrasonic observation device 13, respectively.

In the ultrasonic diagnostic apparatus 70, the CPUs 30a, 30b, and 40 function as alarm controllers 76a, 76b, and 77, respectively. In addition, alarm LEDs 78a and 78b are provided in the first and second ultrasonic probes 11 and 12, respectively.

The wireless communication circuits 71a, 71b, and 72 are basically the same as the wireless communication circuits 34a, 34b, and 42 of the first embodiment except that the each of the wireless communication circuits 71a, 71b, and 72 is provided with a received power measuring section 80. The received power measuring sections 80 measure magnitudes of the received power of the various radio signals received by the wireless communication circuits 71a, 71b, and 72 through the antenna 35a, 35b, and 47, respectively.

Each of the alarm controllers 76a of the first ultrasonic probe 11, 76b of the second ultrasonic probe 12, and 77 of the ultrasonic observation device 13 controls an alarm or warning, using the alarm LEDs 78a and 78b, indicating degradation of communication quality due to reduction in received power of the radio signals. The alarm controllers 76a and 76b perform lighting control of the alarm LEDs 78a and 78b. The alarm controller 77 controls the alarm or warning display on the monitor 24 through the display control circuit 45.

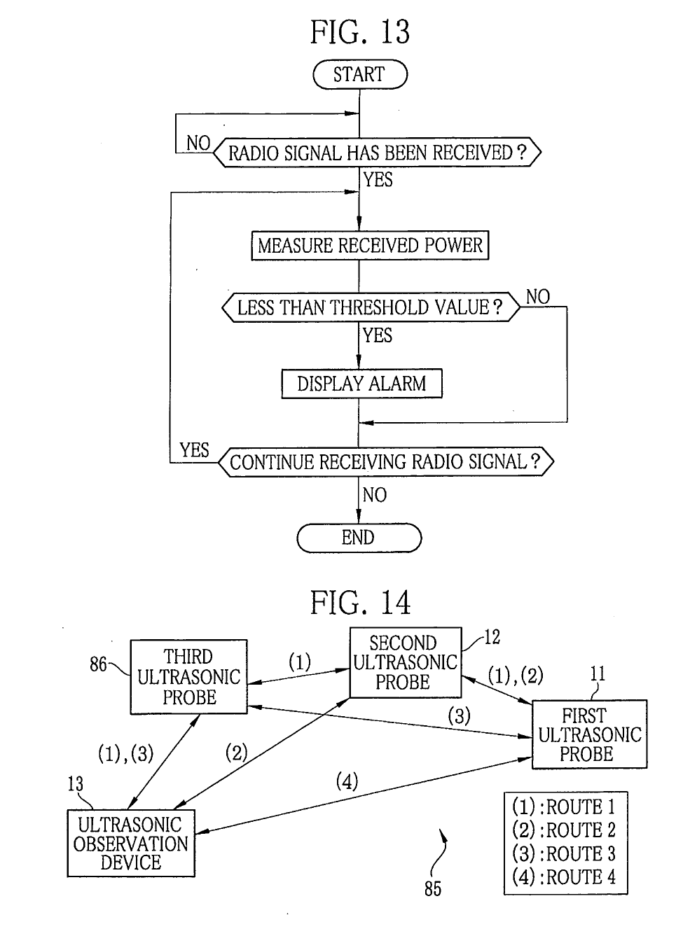

With referring to FIG. 13, an operation of the ultrasonic diagnostic apparatus 70 having the above configuration is described. The wireless communication circuits 71a, 71b, and 72 of the first and second ultrasonic probes 11, 12, and the ultrasonic observation device 13 actuate the received power measuring sections 80 when the wireless communication circuits 71a, 71b, and 72 receive various radio signals through the antennas 35a, 35b, and 47, respectively. Sources of the radio signals are not particularly limited.

The received power measuring sections 80 measure the received power of the radio signals input to the wireless communication circuits 71a, 71b and 72, and output the measurement results to the CPUs 30a, 30b and 40, respectively. Based on the measurement results, the alarm controllers 76a, 76b and 77 monitor whether the received power drops below a predetermined threshold value. The threshold value is set to a value equal to or above which the degradation of communication quality, e.g. communication interruption, does not occur.

Each of the alarm controllers 76a, 76b, and 77 judges that the communication quality is good or normal when the measurement result of the received power is equal to or above the threshold value, and continues monitoring of the measurement input from the received power measuring section 80. On the other hand, when the measurement result drops below the threshold value in the first ultrasonic probe 11, the alarm controller 76a turns on the alarm LED 78a. When the measurement result drops below the threshold value in the second ultrasonic probe 12, the alarm controller 76b turns on the alarm LED 78b. The alarm controller 77 of the ultrasonic observation device 13 displays an alarm message and the like on the monitor 24 through the display control circuit 45. This directs the attention of the operator to move the first or second ultrasonic probe 11 or 12 closer to a source of the radio signals or remove an obstruction to get the communication status back to normal. Thus, the degradation of communication quality among the first and second ultrasonic probes 11 and 12, and the ultrasonic observation device 13 is prevented. Alarm displays are not particularly limited to the above. Instead or in addition to the alarm LEDs 78a and 78b, audible sounds may be used as the alarm.

Next, an ultrasonic diagnostic apparatus 85 of the fourth embodiment of the present invention is described. As shown in FIG. 14, in the ultrasonic diagnostic apparatus 85, multiple ultrasonic probes relay the radio signals, namely, a third ultrasonic probe 86 is added to the ultrasonic diagnostic apparatus having the configuration of the above first, second, or third embodiment. The third ultrasonic probe 86 has the same configuration as the first and second ultrasonic probes 11 and 12. Hereinafter, a suffix “c” is added to a numeral of a component or part of the third ultrasonic probe 86.

In the ultrasonic diagnostic apparatus 85, the coverage of the first to third ultrasonic probes 11, 12 and 86, and that of the ultrasonic observation device 13 overlap with each other. Accordingly, the following four routes (1) to (4) for transmitting and receiving the radio signals are available. An optimum transmission route is selected from the routes (1) to (4).
Route 1: the first ultrasonic probe 11→the second ultrasonic probe 12→the third ultrasonic probe 86→the ultrasonic observation device 13
Route 2: the first ultrasonic probe 11→the second ultrasonic probe 12→the ultrasonic observation device 13
Route 3: the first ultrasonic probe 11→the third ultrasonic probe 86→the ultrasonic observation device 13
Route 4: the first ultrasonic probe 11→the ultrasonic observation device 13

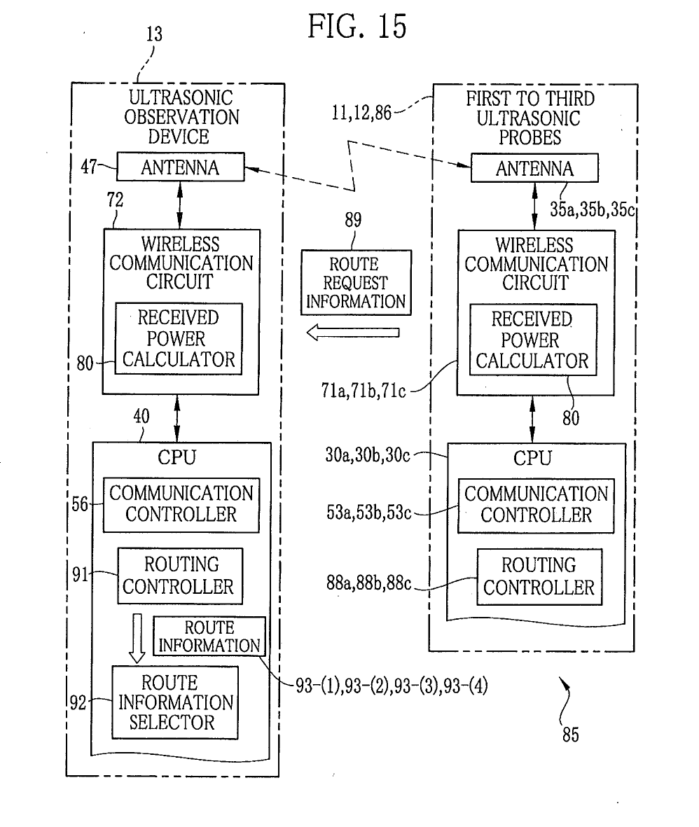

As shown in FIG. 15, the ultrasonic diagnostic apparatus 85 basically has the same configuration as the ultrasonic diagnostic apparatus 70 of the third embodiment which measures the received power of the radio signals, except that a routing controller 88a of the first ultrasonic probe 11 generates route request information 89 different from that in the first embodiment. In this route request information 89, the measurement results of the received power of the radio signals in the relay probe and those in the destination are stored in addition to the identification information. In the route request information 89, the routing controllers 88b, 88c, and 91 store the measurement results of the received power of the respective measuring sections 80.

In the ultrasonic diagnostic apparatus 85, the CPU 40 of the ultrasonic observation device 13 functions as the routing controller 91 different from the third embodiment and as a route information selector 92. In the case where there are four transmission routes of the radio signals, the routing controller 91 generates the first to the fourth route information 93-(1) to 93-(4) corresponding to the four transmission routes. The route information selector 92 compares the first to the fourth route information 93-(1) to 93-(4), and selects the optimum transmission route.

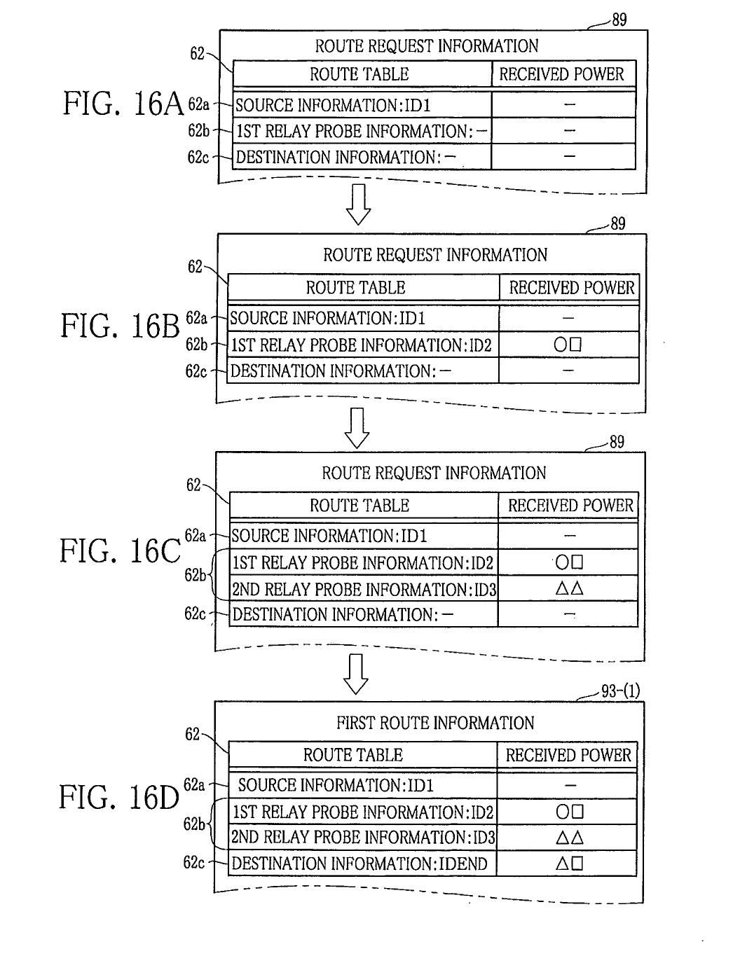

Generation of the first route information 93-(1) is described with referring to FIGS. 16A to 16D. As shown in FIG. 16A, the route request information 89 generated by the routing controller 88a is modulated into radio signals and then broadcasted. The broadcast radio signals are received by the second ultrasonic probe 12.

Thereafter, the radio signals are demodulated into the route request information 89, and then input to the routing controller 88b. The received power of the radio signals is measured by the received power measuring section 80. The measurement results are input to the routing controller 88b.

As shown in FIG. 16B, the routing controller 88b stores the measurement results of the received power in the box 62b for the relay probe information in association with the identification information of the second ultrasonic probe 12. Thereafter, the route request information 89 is modulated into the radio signals and then broadcasted, and received by the third ultrasonic probe 86.

Hereinafter, as shown in FIG. 16C, in the same manner as the above, the routing controller 88c of the third ultrasonic probe 86 stores the identification information and the measurement results of the received power, and the route request information 89 is modulated into the radio signals and then broadcasted. Thereafter, as shown in FIG. 16D, the routing controller 91 of the ultrasonic observation device 13 stores the identification information and the measurement results of the received power. Thus, the first route information 93-(1) is generated.

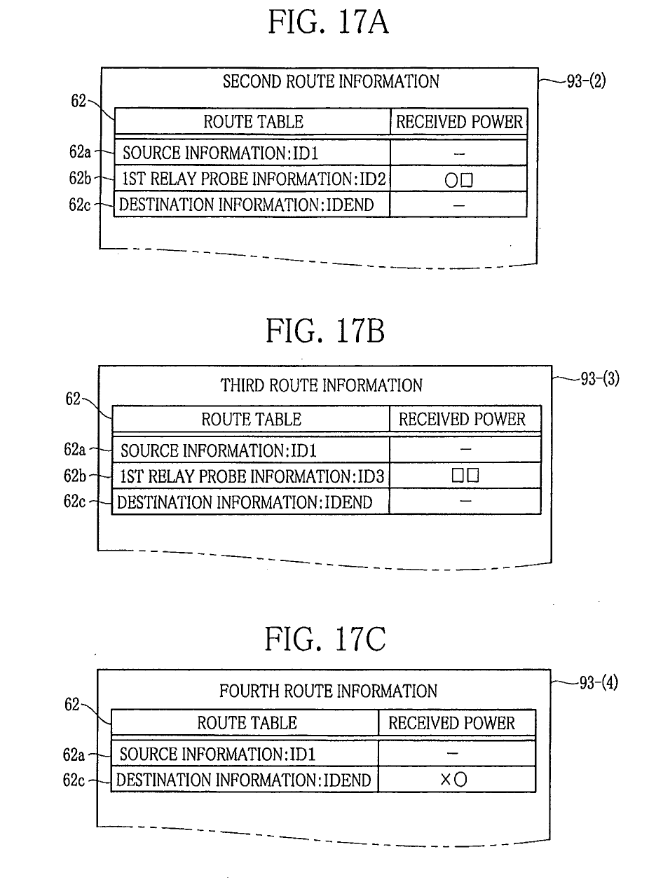

As shown in FIGS. 17A to 17C, the second to fourth route information 93-(2) to 93-(4) is generated as with the first route information 93-(1). The first to fourth route information 93-(1) to 93-(4) is input from the routing controller 91 to the route information selector 92.

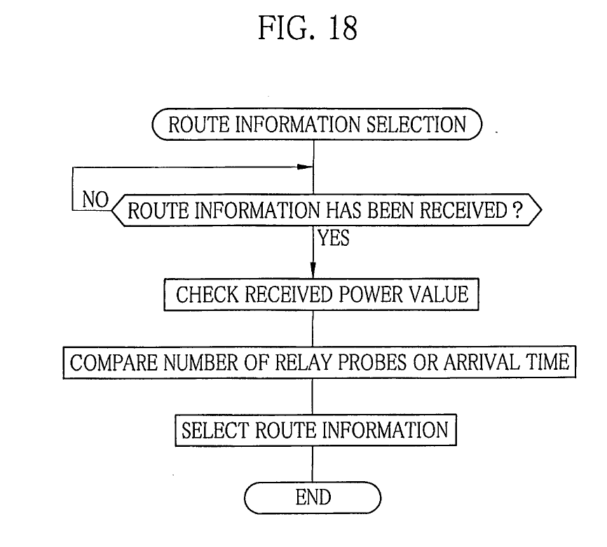

As shown in FIG. 18, the route information selector 92 checks the received power values stored in each of the first to fourth route information 93-(1) to 93-(4), and picks up the route information in which all of the received power values exceed the above described threshold value. In other words, the route information selector 92 selects the route information not causing the degradation of communication quality as described in the third embodiment. From among the picked up route information, the route information selector 92 selects the route information having the least number of relay probes, or which transmits the radio signals to the ultrasonic observation device 13 in the shortest time. Instead, the route information with the highest received power may be selected.

The route information selected by the route information selector 92 is alternately stored in the memory and unicasted as described in FIG. 7, and thus the selected route information is shared by the ultrasonic observation device 13, the second ultrasonic probe 12 used as the relay probe, and the first ultrasonic probe 11. Using the selected route information, the serial signals from the first ultrasonic probe 11 are transmitted to the ultrasonic observation device 13 via multiple relay probes as access point devices. The multiple relay probes provide the robust and optimum wireless communication network.

In the above fourth embodiment, three ultrasonic probes are used. Alternatively, the route information is generated and selected, and the radio signals are relayed among four or more ultrasonic probes as with the above.

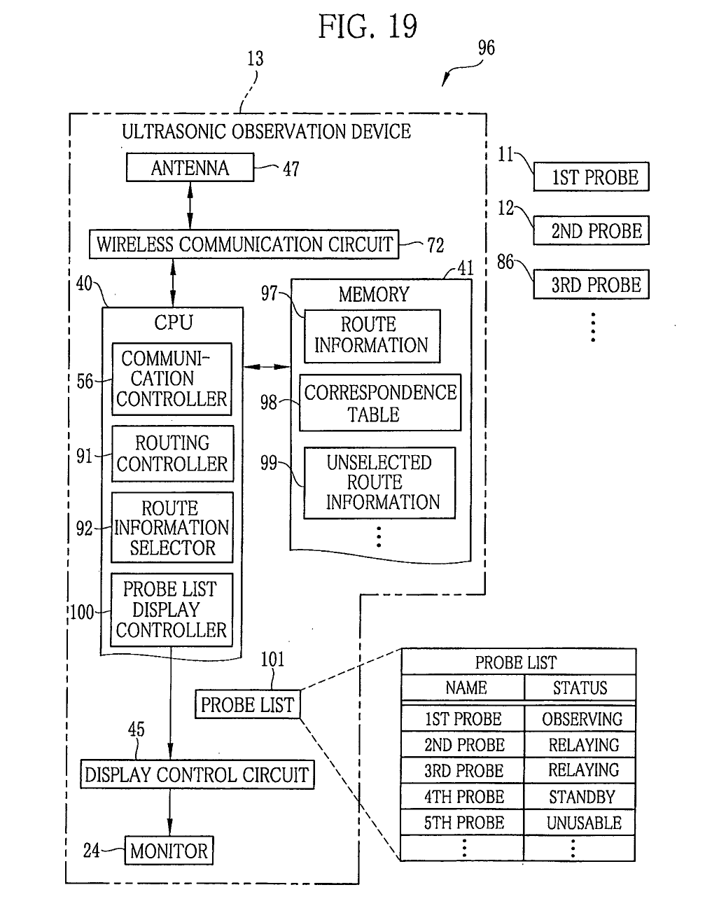

Next, an ultrasonic diagnostic apparatus 96 of the fifth embodiment of the present invention is described with referring to FIG. 19. The ultrasonic diagnostic apparatus 96 is basically the same as the ultrasonic diagnostic apparatus 85 of the above fourth embodiment except that a list of ultrasonic probes is displayed. It should be noted that the ultrasonic diagnostic apparatus 96 uses four or more ultrasonic probes.

In the ultrasonic diagnostic apparatus 96, route information (probe information) 97 selected by the route information selector 92, a correspondence table 98, and multiple unselected route information (probe information) 99 is stored in the memory 41 of the ultrasonic observation device 13. In the ultrasonic diagnostic apparatus 96, the CPU 40 of the ultrasonic observation device 13 functions as a probe list display controller 100.

In the correspondence table 98, identification information and name of each of the ultrasonic probe are associated with each other and stored. The unselected route information 99 refers to the route information which is generated by the routing controller 91 but not selected by the route information selector 92.

The probe list display controller 100 generates a probe list 101 based on the route information 97, the correspondence table 98, and the unselected route information 99 stored in the memory 41, and displays the generated probe list 101 on the monitor 24 via the display control circuit 45.

The probe list 101 is composed of a column indicating names of the ultrasonic probes listed in the correspondence table 98, and a column indicating the usage status of the ultrasonic probes. The usage status include “observing”, “relaying”, “standby”, and “unusable”.

The usage status “observing” indicates that the ultrasonic probe is currently used for the ultrasonic diagnosis. The usage status “relay” indicates that the ultrasonic probe is currently used for relaying. The usage status “standby” indicates that the ultrasonic probe is not currently used for the ultrasonic diagnosis and relaying, but usable for those purposes. The usage status “unusable” indicates that the ultrasonic probe is unusable for the ultrasonic diagnosis and relaying, namely, for example, the ultrasonic probe has been turned off.

The probe list display controller 100 retrieves the names of the ultrasonic probes in the observing status and those in the relaying status based on the identification information stored in the box 62a for source information and the box 62b for the relay probe information in the route information 97, with referring to the correspondence table 98. Based on the retrieved names, the probe list display controller 100 enters “observing” or “relaying” in a cell of the status column in the probe list 101.

Then the probe list display controller 100 compares the route information 97 and the unselected route information 99, and picks up the identification information of the ultrasonic probes not stored in the route information 97, namely, the ultrasonic probes not being used for observation or relaying. The probe list display controller 100 refers to the correspondence table 98 and enters “standby” in the corresponding cells of the status column in the probe list 101.

The probe list controller 100 enters “unusable” in cells of the status column where none of “observing”, “relaying”, and “standby” is entered.

The usage status (observing, relaying, standby, or unusable) of the ultrasonic probes is checked by the operator at a glance at the probe list 101 on the monitor 24. Alternatively, the usage status of each ultrasonic probe may be displayed individually on the monitor 24.

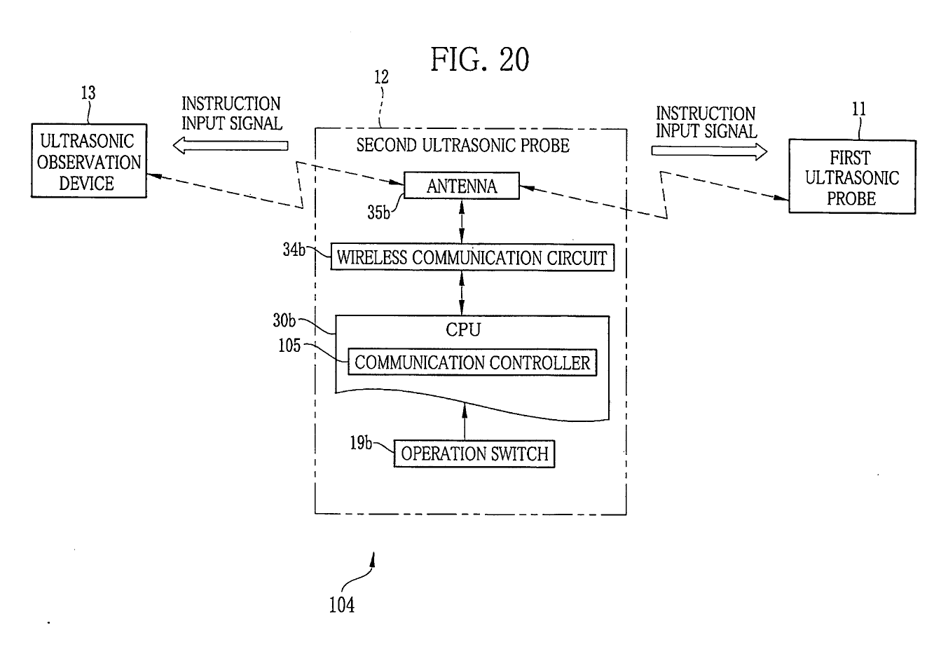

An ultrasonic diagnostic apparatus 104 of the sixth embodiment of the present invention is described with referring to FIG. 20. In the ultrasonic diagnostic apparatuses in the above first to fifth embodiments, an instruction input signal is relayed from the first ultrasonic probe 11 being used in the ultrasonic diagnosis to the ultrasonic observation device 13 as with the serial signal when the operation switch 19a of the first ultrasonic probe 11 is operated. Examples of the operations performed by inputting the instruction input signals include freezing of an ultrasonic image displayed on the monitor 24 and adjustments in signal processing such as gain correction performed in the image processor 50 of the ultrasonic observation device 13.

On the other hand, the ultrasonic diagnostic apparatus 104 of the sixth embodiment allows the operator to input an operation instruction from the second ultrasonic probe 12, being used for relaying the radio signals, to be performed by the first ultrasonic probe 11 or the ultrasonic observation device 13. The ultrasonic diagnostic apparatus 104 has the same configuration as that in the first embodiment, except that a communication controller 105 of the second ultrasonic probe 12 has a different function.

The communication controller 105 determines the destination of an instruction input signal when this instruction input signal is input from the operation switch 19b to the CPU 30b. The destination of the instruction input signal conforms to that of the serial signal. Hereinafter, as with the first embodiment, the communication controller 105 transmits the instruction input signal to the wireless communication circuit 34b, and issues an order to the wireless communication circuit 34b to unicast the instruction input signal to the ultrasonic observation device 13 designated as the destination. Thereby, the ultrasonic observation device 13 receives the instruction input signal, and is controlled based on the received instruction input signal.

When the operation switch 19b of the second ultrasonic probe 12 is used to control the first ultrasonic probe 11, for example, to change the operation mode, the communication controller 105 refers to the route information 58 and unicasts the instruction input signal to the first ultrasonic probe 11 designated as the destination. Thus, the instruction input signal is transmitted from the second ultrasonic probe 12 to the first ultrasonic probe 11, and the first ultrasonic probe 11 is controlled based on the received instruction input signal. In other words, the first ultrasonic probe 11 is controlled using the operation switch 19b of the second ultrasonic probe 12 as the operation switch 19a of the first ultrasonic probe 11. The scan head 16a of the first ultrasonic probe 11 is held with one hand as shown in FIG. 1, enabling an operator to operate the operation switch 19b with the other hand.

As described above, the first ultrasonic probe 11 or the ultrasonic observation device 13 is operated without operating the operation switch 19a of the first ultrasonic probe 11 used for the ultrasonic diagnosis. This prevents a displacement of the first ultrasonic probe 11 from its proper examination position caused by the operation of the operation switch 19a.

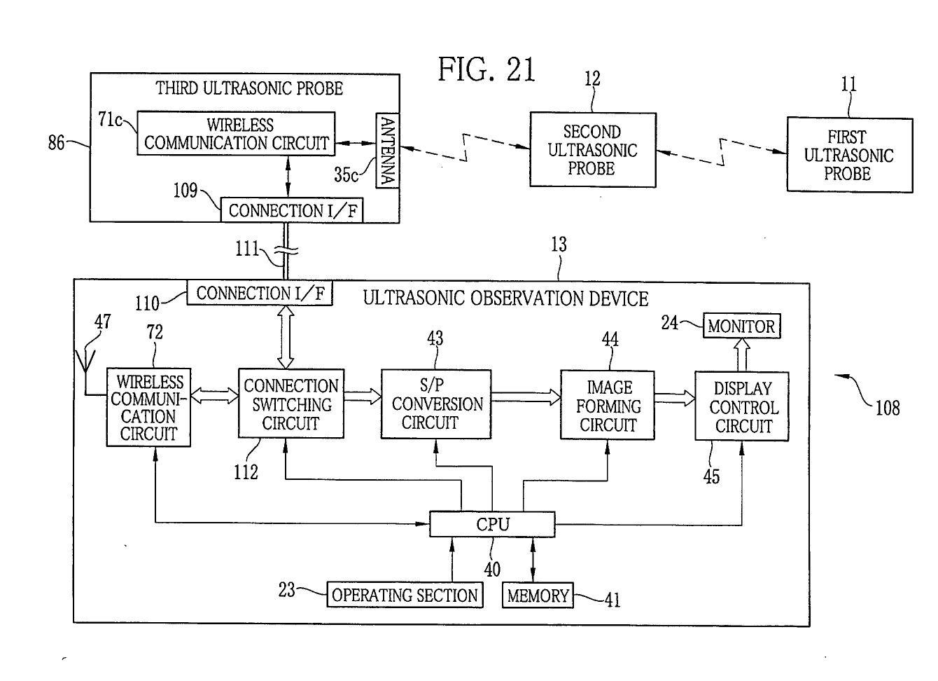

An ultrasonic diagnostic apparatus 108 of the seventh embodiment of the present invention is described with referring to FIG. 21. The ultrasonic diagnostic apparatus 108 has basically the same configuration as the ultrasonic diagnostic apparatus 85 of the fourth embodiment provided with the first to third ultrasonic probes 11, 12, and 86, except that the third ultrasonic probe 86 and the ultrasonic observation device 13 are connected via wired connection in the ultrasonic diagnostic apparatus 108.

To be more specific, a connection I/F 109 is provided in each of the ultrasonic probes 11, 12, and 86 (only the ultrasonic 86 is shown), and a connection I/F 110 is provided in the ultrasonic observation device 13. The connection I/F 109 of the third ultrasonic probe 86 and the connection I/F 110 are connected via a cable 111. The connection I/F 109 is connected to a wireless communication circuit 71c.

The ultrasonic observation device 13 is provided with a connection switching circuit 112 connected to the CPU 40, the S/P conversion circuit 43, the wireless communication circuit 72, and the connection I/F 110. Under the control of the CPU 40, the connection switching circuit 112 connects one of the wireless communication circuit 72 and the connection I/F 110 to the CPU 40 and to the S/P conversion circuit 43.

In the case where the third ultrasonic probe 86 is not connected to the connection I/F 110 via the cable 111, the connection switching circuit 112 connects the wireless communication circuit 72 to the CPU 40 and to the S/P conversion circuit 43. On the other hand, in the case where the third ultrasonic probe 86 is connected to the connection I/F 110 via the cable 111, the connection I/F 110 is connected to the CPU 40 and to the S/P conversion circuit 43.

In the case where the third ultrasonic probe 86 and the ultrasonic observation device 13 are connected via the cable 111, the radio serial signal received by an antenna 35c of the third ultrasonic probe 86 is demodulated into the serial signal by the wireless communication circuit 71c. The serial signal is input to the S/P conversion circuit 43 through the connection I/F 109, the cable 111, the connection I/F 110, and the connection switching circuit 112. On the other hand, the route information and the like generated by the CPU 40 follows the same path in reverse and are input to the wireless communication circuit 71c.

As described above, the ultrasonic observation device 13 can use the antenna 35c and the wireless communication circuit 71c of the third ultrasonic probe 86 instead of the antenna 47 and the wireless communication circuit 72 of its own. Even if the second ultrasonic probe 12 and the ultrasonic observation device 13 are far apart and both of them are out of the coverage of the third ultrasonic probe 86, a wireless communication network can be established by extending the cable 111 and bringing the third ultrasonic probe 86 close to the second ultrasonic probe 12. A wireless communication network is established even when the antenna 47 or the wireless communication circuit 72 of the ultrasonic observation device 13 is broken.

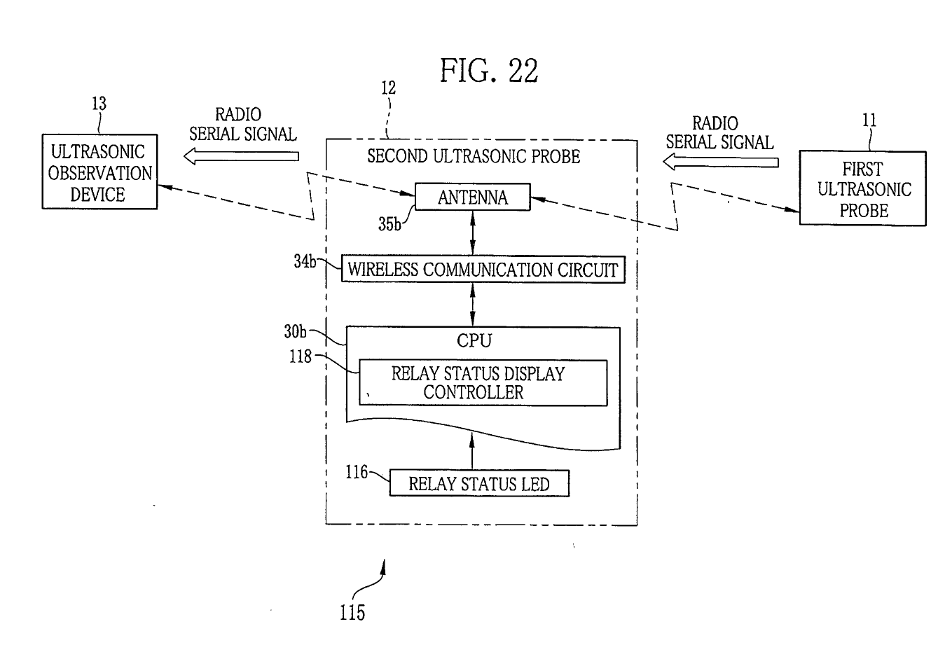

An ultrasonic diagnostic apparatus 115 of the eighth embodiment of the present invention is described with referring to FIG. 22. The configuration of the ultrasonic diagnostic apparatus 115 is basically the same as the ultrasonic diagnostic apparatus 10 in the above first embodiment, except that each of the ultrasonic probes 11 and 12 is provided with a relay status LED 116 (the relay status LED 116 is only shown in the second ultrasonic probe 12). The relay status LED 116 indicates whether relaying of radio signals is performed. The CPUs 30a and 30b of the first and second ultrasonic probes 11 and 12 function as relay status display controllers 118, respectively (the relay status display controller 118 is only shown in the second ultrasonic probe 12).

The relay status display controller 118 turns on the relay status LED 116 when the ultrasonic probe 12 is used for relaying various radio signals such as radio serial signals, or when the wireless communication circuit 34b performs relaying of the radio signals. Thereby, the second ultrasonic probe 12 currently used for relaying is prevented from being used for other purposes by error. Instead of using the relay status LED 116, the relaying of the radio signals can be notified by an alarm display or audible sound.

When the ultrasonic probe is used for relaying, the functions for the ultrasonic diagnostic use may be disabled. Alternatively or in addition, a message may be displayed to confirm whether this ultrasonic probe is available for the diagnostic use.

Two or more of the above described first to the eighth embodiments may be used in combination.

In each of the above embodiments, only one ultrasonic observation device 13 is provided. The present invention is also applicable to the case where multiple ultrasonic observation devices 13 are provided. In this case, multiple route information having different destinations is generated, and the route information most quickly responded to the first ultrasonic probe 11 is selected.

Various changes and modifications are possible in the present invention and may be understood to be within the present invention.

What is claimed is:

1. A wireless ultrasonic diagnostic apparatus comprising:
multiple ultrasonic probes, the ultrasonic probes including a first ultrasonic probe being used for ultrasonic diagnosis and one or more second ultrasonic probes not being used for the ultrasonic diagnosis;
an ultrasonic observation device used for the ultrasonic diagnosis;
a wireless communication section provided in each of the ultrasonic probes and the ultrasonic observation device, the wireless communication section wirelessly transmitting and receiving a radio signal related the ultrasonic diagnosis;
a wireless communication controller provided in each of the ultrasonic probes to control the wireless communication section, the wireless communication controller of the second ultrasonic probe controlling its wireless communication section to relay the radio signal such that the radio signal is communicated between the first ultrasonic probe and the ultrasonic observation device via the one or more second ultrasonic probes.

2. The wireless ultrasonic diagnostic apparatus of claim 1, wherein each of the ultrasonic probes and the ultrasonic observation device has a routing controller for constructing a route for wireless communication between the first ultrasonic probe and the ultrasonic observation device.

3. The wireless ultrasonic diagnostic apparatus of claim 2, wherein each of the ultrasonic probes and the ultrasonic observation device has a received power detector for detecting magnitude of received power of the radio signal received by the wireless communication section, and the routing controller constructs the route based on a detection result of the received power detector.

4. The wireless ultrasonic diagnostic apparatus of claim 1, wherein each of the ultrasonic probes and the ultrasonic observation device includes a received power detector and an alarm display section, and the received power detector detects received power of the radio signals received by the wireless communication section, and the alarm display section gives an alarm when a detection result of the received power detector is lower than a threshold value.

5. The wireless ultrasonic diagnostic apparatus of claim 1, wherein each of the ultrasonic probes has a backup section for temporarily storing backup data of the radio signals received by the wireless communication section.

6. The wireless ultrasonic diagnostic apparatus of claim 1, wherein the ultrasonic observation device includes a display section for displaying a usage status of the one or more ultrasonic probes.

7. The wireless ultrasonic diagnostic apparatus of claim 6, wherein the radio signal transmitted from the first ultrasonic probe to the ultrasonic observation device via the one or more second ultrasonic probes includes identification information of the first and second ultrasonic probes and probe information indicating the usage status of the first and second ultrasonic probes, and the ultrasonic observation device includes a display controller for controlling the display section to display the usage status of the first and second ultrasonic probes in a form of a list based on the identification information and the probe information.

8. The wireless ultrasonic diagnostic apparatus of claim 7, wherein the usage status includes a diagnosing status in which the ultrasonic probe is being used for the ultrasonic diagnosis, a relaying status in which the ultrasonic probe is being used for relaying the radio signals, and a status in which the ultrasonic probe is available for one of the ultrasonic diagnosis and the relaying.

9. The wireless ultrasonic diagnostic apparatus of claim 1, wherein each of the ultrasonic probes is provided with an instruction input section for receiving an instruction input signal for operating the ultrasonic probe or the ultrasonic observation device, and in the second ultrasonic probe the wireless communication controller controls the wireless communication section to wirelessly transmit the instruction input signal, received by the instruction input section, to the wireless communication section of the first ultrasonic probe or to the wireless communication section of the ultrasonic observation device, and the first ultrasonic probe or the ultrasonic observation device operates according to the received instruction input signal.

10. The wireless ultrasonic diagnostic apparatus of claim 1, further including a connection section for connecting the second ultrasonic probe in relay and the ultrasonic observation device via wired connection, and the wireless communication section of the connected second ultrasonic probe functions as the wireless communication section of the ultrasonic observation device.

11. The wireless ultrasonic diagnostic apparatus of claim 1, wherein each of the ultrasonic probes is provided with a relay status indicator to indicate that the wireless communication section is relaying the radio signal.

12. An ultrasonic probe comprising:
a wireless communication section for transmitting and receiving a radio signal related to ultrasonic diagnosis; and
a wireless communication controller for controlling the wireless communication section to relay the radio signal during standby for the ultrasonic diagnosis between other two ultrasonic probes or between another ultrasonic probe and an ultrasonic observation device used for the ultrasonic diagnosis.
